(19) United States
(12) Patent Application Publication
(10) Pub. No.: US 2009/0100233 A1
(43) Pub. Date: Apr. 16, 2009

(54) PERSISTENT MEMORY MODULE

(75) Inventor: Tom Worster, Boston, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/872,740

(22) Filed: Oct. 16, 2007

(51) Int. Cl. G06F 12/00; G06F 13/20

(52) U.S. Cl. 711/154; 710/313; 711/E12.001

(57) ABSTRACT

A persistent memory module (100). The persistent memory module can include a daughter board (130), a persistent memory (110) disposed on the daughter board, and a memory controller (120) disposed on the daughter board. The memory controller can interface with a communication bus (150) to provide access to the persistent memory via the communication bus.

### FIELD OF THE INVENTION

The present invention generally relates to computer systems and, more particularly, to persistent memory.

### BACKGROUND OF THE INVENTION

Single-board computers are complete computers built on a single circuit board, and typically include one or more processors, random access memory (RAM), input/output ports, and various other features needed to be a functional computer. As a result of their high level of integration, single-board computers are typically smaller, lighter, more energy efficient and more reliable than other types of computers. Accordingly, single-board computers provide an attractive solution for use in blade servers and other rack-mount computing systems. Single-board computers also are used in various other types of systems that benefit from their form factor, efficiency and reliability, for example in telecommunications equipment, networking equipment, gaming machines, kiosks and machine control systems.

Single board computers often do not offer a feature of persistent memory, that is, a block of memory which has a state that persists over reset and restart of the computer. Some applications demand such a feature, however, and thus are not compatible with single board computers that do not have persistent memory.

### SUMMARY OF THE INVENTION

The present invention relates to a persistent memory module. The persistent memory module can include a daughter board, a persistent memory disposed on the daughter board, and a memory controller disposed on the daughter board. The memory controller can interface with a communication bus to provide access to the persistent memory via the communication bus.

The present invention also relates to a single board computer. The single board computer can include a mainboard, a connector attached to the mainboard, and a persistent memory module engaging the connector. The persistent memory module can include a daughter board, a persistent memory disposed on the daughter board, and a memory controller disposed on the daughter board. The memory controller can interface with a communication bus of the single board computer to provide access to the persistent memory via the communication bus.

The present invention further relates to a method for managing data. The method can include communicatively linking persistent memory that is disposed on a daughter board to at least one processor via a communication bus, managing data flow to and from the persistent memory, and maintaining the data in the persistent memory during a plurality of operation modes of a system including the at least one processor.

### BRIEF DESCRIPTION OF THE DRAWINGS

Preferred embodiments of the present invention will be described below in more detail, with reference to the accompanying drawings, in which:

FIG. 1 depicts a block diagram of a computer to which a persistent memory module is connected, which is useful for understanding the present invention;

FIG. 2 depicts a view of a persistent memory module that is useful for understanding the present invention;

FIG. 3 depicts another view of a persistent memory module that is useful for understanding the present invention; and

FIG. 4 is a flowchart presenting a method that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a persistent memory module 100 that can be installed into a computer which otherwise lacks persistent memory. Accordingly, applications and functions that require persistent memory, and thus otherwise would be incompatible with such a computer, can be executed on the computer. In particular, the persistent memory module can maintain data required by such applications through reset and/or restart of the computer.

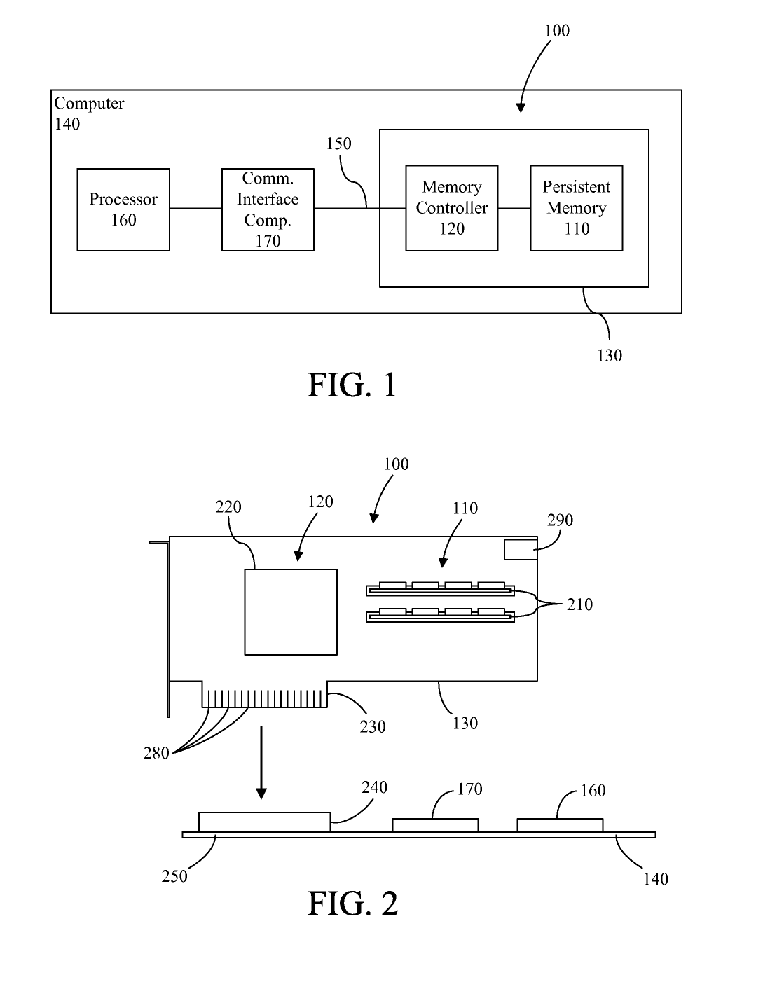

FIG. 1 depicts a block diagram of a computer 140 to which a persistent memory module 100 is connected. The persistent memory module 100 can include persistent memory 110 and a memory controller 120 disposed on a daughter board 130. As used herein, the term “persistent memory” means memory which may be configured to retain data during a system reboot. In one arrangement, the persistent memory 110 can be random access memory (RAM). Examples of suitable RAM can include, but are not limited to, dynamic RAM (DRAM), static RAM (SRAM) synchronous DRAM (SDRAM), double data rate SDRAM (DDR SDRAM), DDR2 SDRAM, DDR3 SDRAM, rambus DRAM (RDRAM), and the like. In such an arrangement, the RAM can maintain data so long as power is applied to the persistent memory 110 and the memory controller 120.

The memory controller 120 can manage the flow of data going to and from the persistent memory 110. Optionally, if the persistent memory 110 requires memory refreshes to maintain data in the persistent memory 110 during operation of the computer 140, the memory controller 120 can provide such refreshes. The memory controller 120 also can provide memory refreshes during reset and/or restart of the computer so long as power is maintained to the memory controller. The refresh rate can be suitably configured for the type of persistent memory 110 being used. For example, in accordance with the JEDEC Solid State Technology Association standards applicable to DRAM, the refresh rate can be configured to be approximately sixty four milliseconds. Nonetheless, other types of RAM may have different refresh rate requirements, and thus the invention is not limited in this regard.

The persistent memory module 100 can be coupled to a computer 140, such as a single board computer, via a suitable communication bus 150 in order to provide persistent memory for the computer 140. Accordingly, the persistent memory can be made available to various applications and/or processes executing on the computer. For example, the communication bus 150 can communicatively link the memory controller 120, and thus the persistent memory 110, to one or more processors, for example a processor 160. As such, applications and/or functions executed by the processor 160 can utilize the persistent memory module 100 for persistent data storage.

In one arrangement, the communication bus 150 can be implemented as a peripheral component interconnect (PCI) interface or a PCI express interface. In another arrangement, the communication bus 150 can be a universal serial bus (USB) interface or an Institute of Electrical and Electronics Engineers (IEEE) 1394 interface. Still, the communication bus 150 can be any other interface that provides a suitable communication link between the processor 160 and the memory controller 120 which, as noted, is disposed on the daughter board 130.

In a further arrangement, the communication bus 150, and thus the memory controller 120 and the persistent memory 110, can be communicatively linked to the processor(s) 160 via communication interface components 170. For example, in an arrangement in which the communication bus 150 is implemented as a PCI interface, the communication interface components 170 can include an input/output controller for the PCI interface (e.g. a southbridge). If the communication bus 150 is implemented as a PCI express interface, the communication interface components 170 can include a switch that routes communication data to and from the processor 160, although an input/output controller also can be used in lieu of the switch. If the communication bus 150 is implemented as a USB interface, the communication interface components 170 can include a USB host controller. Similarly, if the communication bus 150 is implemented as an IEEE 1394 interface, the communication interface components 170 can include an IEEE 1394 host controller. Input/output controllers, switches, USB host controllers and IEEE 1394 host controllers are known to the skilled artisan. Notwithstanding, any other communication interface components can be provided and the invention is not limited in this regard.

Suitable drivers can be provided for use by applications and/or functions executed by the processor(s) 160 that require use of the persistent memory 110. Such drivers can be abstracted into logical and/or physical layers within an operating system instantiated on the computer 140 and, at runtime, facilitate communication between the applications and/or functions and the memory controller 120. The use of device drivers is well known to those skilled in the art.

FIG. 2 depicts a view of the persistent memory module 100 that is useful for understanding the present invention. As noted, the persistent memory module 100 can comprise the persistent memory 110 and the memory controller 120, which can be disposed on the daughter board 130. The persistent memory 110 can comprise one or more memory modules 210, which are known to the skilled artisan. Further, the memory controller 120 can comprise one or more integrated circuits 220 configured to perform the memory controller functions described herein.

The memory controller 120 and persistent memory 110 can be communicatively linked via circuit traces (not shown for the purpose of clarity), or in any other suitable manner. In addition, the memory controller 120 can be communicatively linked to the processor(s) 160 via a connector 230 that engages a suitable connector 240. The connector 240 can be attached to the computer 140, for instance to a mainboard 250 of the computer 140, and provide a communication link to the processor 160. Such communication link need not be a direct communication link, however. For example, as noted, the communication link also can include additional communication interface components, for example an input/output controller, a switch, etc.

By way of example, if the communication bus is implemented as a PCI interface, the connector 240 can be a PCI socket and the connector 230 can be configured to mate with the PCI socket. Similarly, if the communication bus is implemented as a PCI express interface, the connector 240 can be a PCI express socket and the connector 230 can be configured to mate with the PCI express socket. For instance, the connector 230 can be an extension of the daughter board 130 that includes a plurality of contacts 280 that mate to corresponding contacts (not shown) within the connector 230.

In one arrangement, the persistent memory 110 and memory controller 120 can receive power from the connector 240 via the connector 230. In another arrangement, a separate power connector 290 can be provided on the daughter board 130 to receive power for such components 110, 120.

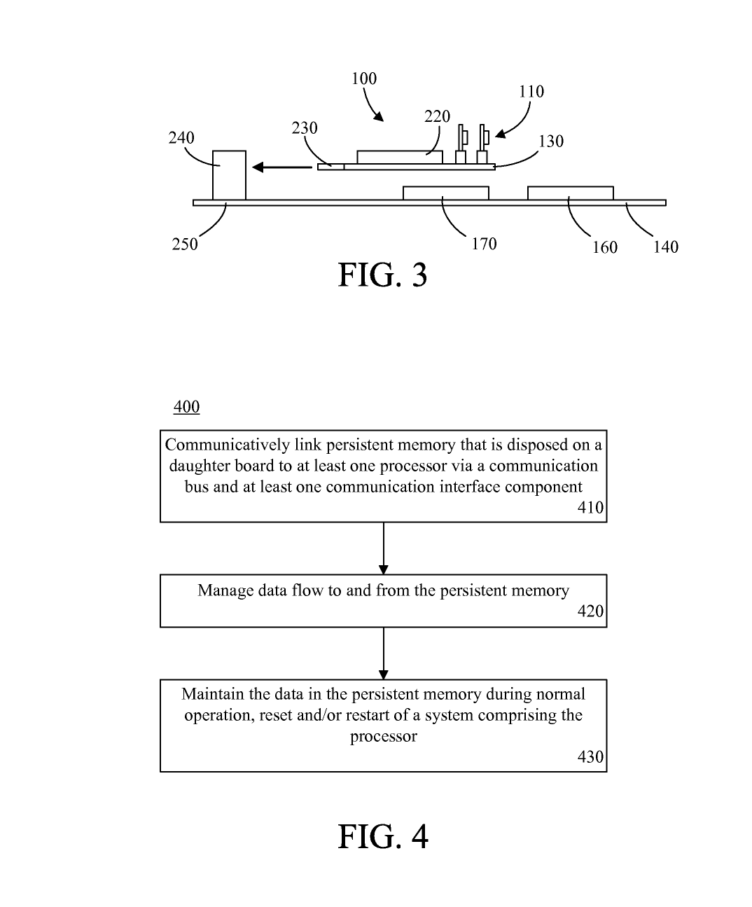

FIG. 3 depicts another view of the persistent memory module 100 that is useful for understanding the present invention. In such an arrangement, the connector 240 can be configured to engage the connector 230 such that the daughter board 130 is parallel or substantially parallel to the mainboard 250. For example, the connectors 230, 240 and the daughter board 130 can be configured in accordance with the IEEE P1386.1 PCI mezzanine card standard or the PCI Industrial Computer Manufacturers Group (PICMG) advanced mezzanine card standard. Still, the connectors 230, 240 and the daughter board 130 can be configured in accordance with any other suitable standards and the invention is not limited in this regard.

FIG. 4 is a flowchart presenting a method 400 for managing data that is useful for understanding the present invention. At step 410, persistent memory that is disposed on a daughter board can be communicatively linked to at least one processor via a communication bus and at least one communication interface component. As noted, the communication interface component can be an input/output controller, a switch, a USB host controller or an IEEE 1394 host controller. At step 420, data flow to and from the persistent memory can be managed. At step 430, data can be maintained in the persistent memory while power to the memory controller is maintained. Accordingly, the data can be maintained during the various operation modes of a system comprising the processor, for example during reset, restart and/or normal operation.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof Accordingly, reference should be made to the following claims, rather than to the foregoing specification, as indicating the scope of the invention.

What is claimed is:

1. A persistent memory module, comprising:
a daughter board;
a persistent memory disposed on the daughter board; and
a memory controller disposed on the daughter board, the memory controller interfacing with a communication bus to provide access to the persistent memory via the communication bus.

2. The persistent memory module of claim 1, wherein:
the communication bus is a communication bus of a single board computer; and
the memory controller provides to the single board computer access to the persistent memory via the communication bus.

3. The persistent memory module of claim 1, wherein:
the memory controller is communicatively linked to at least one processor via the communication bus; and
the memory controller provides to the processor access to the persistent memory.

4. The persistent memory module of claim 3, wherein the communication bus is a peripheral component interconnect (PCI) bus.

5. The persistent memory module of claim 3, wherein the communication bus is a PCI express bus.

6. The persistent memory module of claim 3, wherein the memory controller is further communicatively linked to the at least one processor via an input/output controller.

7. The persistent memory module of claim 3, wherein the memory controller is further communicatively linked to the at least one processor via a switch.

8. The persistent memory module of claim 3, wherein the memory controller is further communicatively linked to the at least one processor via a universal serial bus (USB) host controller.

9. The persistent memory module of claim 3, wherein the memory controller is further communicatively linked to the at least one processor via an Institute of Electrical and Electronics Engineers (IEEE) 1394 host controller.

10. A single board computer, comprising:
a mainboard;
a connector attached to the mainboard; and
a persistent memory module engaging the connector, the persistent memory module comprising:
a daughter board;
a persistent memory disposed on the daughter board; and
a memory controller disposed on the daughter board, the memory controller interfacing with a communication bus of the single board computer to provide access to the persistent memory via the communication bus.

11. The single board computer of claim 10, wherein:
the memory controller is communicatively linked to at least one processor via the communication bus; and
the memory controller provides to the processor access to the persistent memory.

12. The single board computer of claim 11, wherein the communication bus is a PCI bus.

13. The single board computer of claim 11, wherein the communication bus is a PCI express bus.

14. The single board computer of claim 11, further comprising:
a communication interface component to which the memory controller is communicatively linked, the communication interface component selected from a group consisting of an input/output controller, a switch, a USB host controller and an IEEE 1394 host controller.

15. The single board computer of claim 11, wherein the daughter board and connector are configured in accordance with an IEEE P1386.1 PCI mezzanine card standard or a PCI Industrial Computer Manufacturers Group (PICMG) advanced mezzanine card standard.

16. A method for managing data, comprising:
communicatively linking persistent memory that is disposed on a daughter board to at least one processor via a communication bus;
managing data flow to and from the persistent memory; and
maintaining the data in the persistent memory during a plurality of operation modes of a system comprising the at least one processor.

17. The method of claim 16, wherein maintaining the data in the persistent memory during a plurality of operation modes comprises maintaining the data during a plurality of operation modes selected from the group consisting of reset, restart and normal operation.

18. The method of claim 16, wherein communicatively linking the persistent memory to at least one processor and the at least one communication interface component comprises linking the persistent memory to the at least one communication interface component via a communication interface component.

19. The method of claim 17, further comprising selecting the communication bus to be a PCI bus or a PCI express bus.

20. The method of claim 17, further comprising:
selecting the communication interface component from a group consisting of an input/output controller, a switch, a USB host controller and an IEEE 1394 host controller.
